(19) United States
(12) Patent Application Publication
(10) Pub. No.: US 2010/0262850 A1
(43) Pub. Date: Oct. 14, 2010

(54) Power Budget Controller and Related Method for Ethernet Device

(76) Inventors: Guan-Henry Lin, Taichung (TW); Tsung-Hsuan Wu, Changhua County (TW); Wen-Sheng Hou, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/562,143

(22) Filed: Sep. 18, 2009

(30) Foreign Application Priority Data
Apr. 8, 2009 (TW) 098111711

(51) Int. Cl. G06F 1/32; H04L 12/26

(52) U.S. Cl. 713/320; 370/241

(57) ABSTRACT

A power budget controller for an Ethernet device is disclosed. The Ethernet device is connected with another Ethernet device through a cable. The power budget controller includes a length estimation unit, a power selection unit and a link monitoring unit. The length estimation unit is utilized for generating a detection signal to the cable and for estimating length of the cable according to a refection waveform of the detection signal. The power selection unit is coupled to the length estimation unit, and utilized for adjusting a transmission power of the Ethernet device according to an estimation result of the cable length. The link monitoring unit is coupled to the power selection unit, and utilized for monitoring a link status of the Ethernet device to determine whether the transmission power is selected correctly.

### BACKGROUND OF THE INVENTION

1. Field of the Invention

The present invention relates to a power budget controller and related method for an Ethernet device, and more particularly, to a power budget controller and related method for adjusting a transmission power of the Ethernet device according to a length of a cable.

2. Description of the Prior Art

Ethernet is standardized as IEEE 802.3. So far, it has been widely used in local area networks (LANs). In order to meet all kinds of requirements, Ethernet devices are connected by different network media such as twisted pair cables, coaxial cables, optical fibers and etc., to support the bit rates of 10 Mbps, 100 Mbps, and 1 Gbps.

As known so far, the Ethernet devices are connected by the twist pair, and support the bit rates of 10 Mbps and 100 Mbps. At the beginning of connection, two mutually connected Ethernet devices confirm their connection ability and data rate through a link pulse. For example, the connection can run at 100 Mbps only if both Ethernet devices support the bit rate of 100 Mbps. Otherwise, the lower bit rate, 10 Mbps, is adopted.

However, power consumption in the network system increases with wide use of LANs. Therefore, it becomes a big challenge in design to reduce unnecessary power consumption. In the prior art, the Ethernet device uses a constant power for transmission, regardless of the length of cable. In this situation, it is a waste for the Ethernet devices connected by a short cable to use the same power for transmission as those connected by a long cable.

### SUMMARY OF THE INVENTION

It is therefore an objective of the present invention to provide a power budget controller and related method for an Ethernet device.

The present invention discloses a power budget controller for an Ethernet device. The Ethernet device is connected with another Ethernet device through a cable. The power budget controller includes a length estimation unit, a power selection unit, and a link monitoring unit. The length estimation unit is utilized for generating a detection signal to a cable and estimating a length of the cable according to a reflection waveform of the detection signal. The power selection unit is coupled to the length estimation unit, and utilized for adjusting a transmission power of the Ethernet device according to an estimation result of the cable length. The link monitoring unit is coupled to the power selection unit, and utilized for monitoring a link status of the Ethernet device to determine whether the transmission power is selected correctly.

The present invention further discloses a method of controlling power budget for an Ethernet device. The Ethernet device is connected with another Ethernet device through a cable. The method includes steps of generating a detection signal to a cable and estimating a length of the cable according to a reflection waveform of the detection signal, adjusting a transmission power of the Ethernet device according to an estimation result of the cable length, and monitoring a link status of the Ethernet device to determine whether the transmission power is selected correctly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a power budget controller for an Ethernet device according to an embodiment of the present invention.

FIG. 2 is a schematic diagram of a length estimation unit according to an embodiment of the present invention.

FIG. 3 is a flow chart of a process for controlling power budget for an Ethernet device according to an embodiment of the present invention.

### DETAILED DESCRIPTION

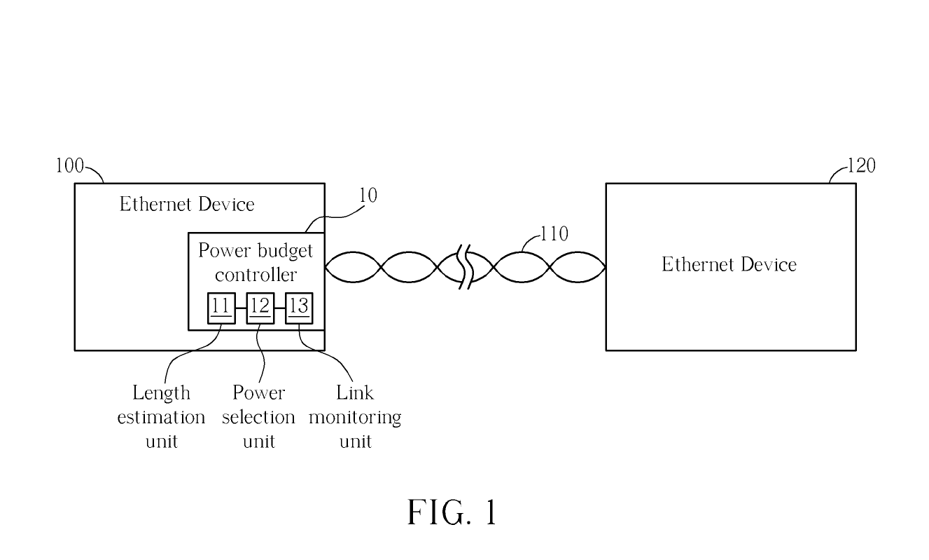

Please refer to FIG. 1, which is a schematic diagram of a power budget controller 10 for an Ethernet device 100 according to an embodiment of the present invention. The Ethernet device 100 is connected with another Ethernet device 120 through a cable 110, for example, a twisted pair cable. The power budget controller 10 includes a length estimation unit 11, a power selection unit 12, and a link monitoring unit 13. The length estimation unit 11 is utilized for generating a detection signal to the cable 110 and estimating a length of the cable 110 according to a reflection waveform of the detection signal. The power selection unit 12 is coupled to the length estimation unit 11, and utilized for adjusting a transmission power of the Ethernet device 100 according to an estimation result of the cable length. The link monitoring unit 13 is coupled to the power selection unit 12, and utilized for monitoring a link status of the Ethernet device 100 to determine whether the transmission power is selected correctly.

Preferably, the detection signal mentioned above is a link pulse, utilized for confirming connection ability and data rate of both Ethernet devices through an auto-negotiation mechanism at the beginning of the connection, and the link monitoring unit 13 monitors the link status of the Ethernet device 100 through a link monitoring process. Detailed operations of the link pulse and the link monitor process can be referred to IEEE 802.3 specifications, and thus are not elaborated on herein.

Therefore, through the power budget controller 10, the embodiment of the present invention can adjust the transmission power according to the length of the cable so as to reduce unnecessary power consumption. Apart from that, the embodiment of the present invention further avoids link down problem due to incorrect power adjustment, by monitoring the link status of the Ethernet device.

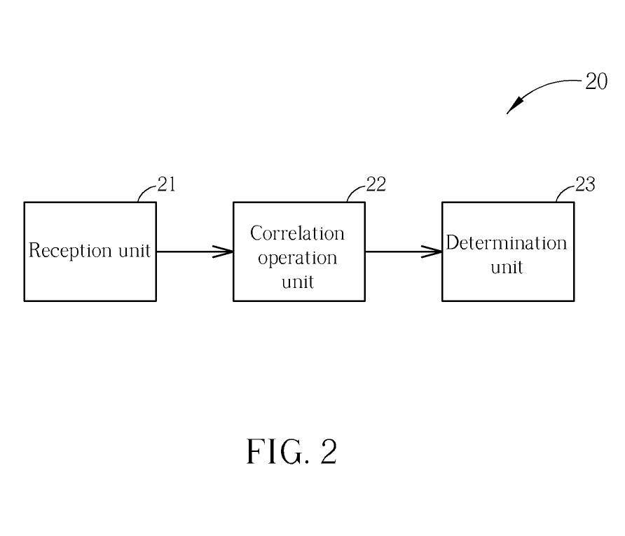

Please refer to FIG. 2, which is a schematic diagram of a length estimation unit 20 according to an embodiment of the present invention. The length estimation unit 20 is utilized for realizing the length estimation unit 11 shown in FIG. 2. The length estimation unit 20 includes a reception unit 21, a correlation operation unit 22, and a determination unit 23. The reception unit 21 is coupled to the cable 110, and utilized for receiving a reflection waveform of the detection signal. The correlation operation unit 22 is coupled to the reception unit 21, and utilized for calculating correlation between the reflection waveform and an expected reflection waveform of the detection signal. Preferably, the correlation operation unit 22 is a correlator, and the expected reflection waveform of the detection signal is stored in a register in advance. The determination unit 23 is coupled to the correlation operation unit 22, and utilized for determining whether the length of the cable is less than a particular value according to the correlation between the reflection waveform and the expected reflection waveform.

As known by those in the art, if the length of the cable is less than the particular value, the superposition of the reflection signal and the incident signal makes signals indistinguishable since a travel time of the reflection signal decreases tremendously. Thus, when the reflection waveform and the expected waveform show a weak correlation, this represents the reflection signal can not be distinguished because the reflection signal likely superposes the detection signal. The embodiment of the present invention thus determines the length of the cable 110 is less than the particular value. On the contrary, when the reflection waveform and the expected waveform show a strong correlation, this represents the reflection waveform is a legal reflection waveform and does not superpose the detection signal. The embodiment of the present invention thus determines the length of the cable 110 is greater than the particular value. In addiction, the determination unit 23 further estimates the length of the cable 110 according to a start time of the reflection waveform, namely, a travel time of the reflection signal.

For different cables, the reflection signal may overlap with the incident signal in different lengths. Take an example of the twisted pair cables, the particular value mentioned above is about twenty meters. Consequently, the embodiment of the present invention adjusts the Ethernet transmission power according to the length of the cable. Regarding the detailed operations of the power budget controller 10, please continue to refer to the following statements.

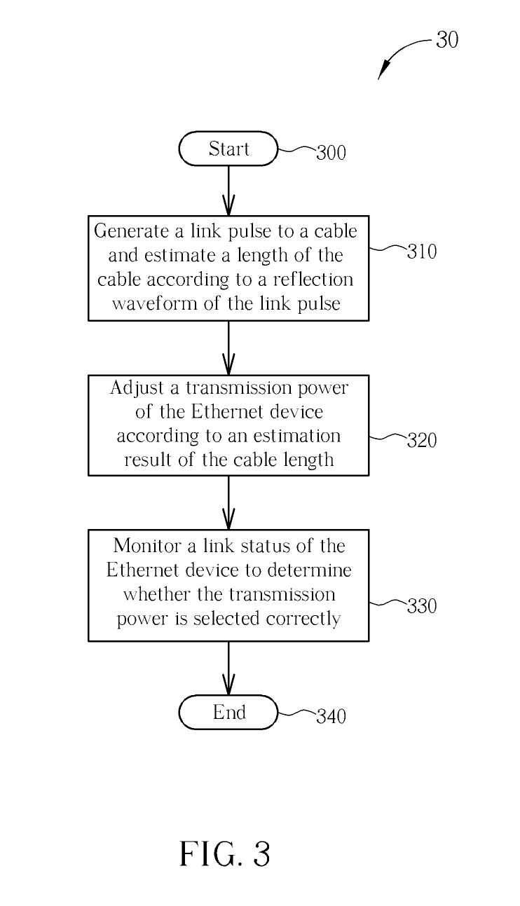

Please refer to FIG. 3, which is a flow chart of a process 30 for controlling power budget for an Ethernet device according to an embodiment of the present invention. The process 30 is utilized for implementing the power budget controller 10 mentioned above, and includes the following steps:

Step 300: Start.

Step 310: Generate a link pulse to a cable and estimate a length of the cable according to a reflection waveform of the link pulse.

Step 320: Adjust a transmission power of the Ethernet device according to an estimation result of the cable length.

Step 330: Monitor a link status of the Ethernet device to determine whether the transmission power is selected correctly.

Step 340: End.

According to the process 30, the length estimation unit 11 first generates the link pulse to the cable, and estimates the length of the cable 110 according to the reflection waveform of the link pulse. Then, the power budget controller 12 adjusts the transmission power of the Ethernet device 100 according to the estimation result of the cable length. Finally, by monitoring the link status of the Ethernet device 100, such as through the link monitoring process, the link monitoring unit 13 determines whether the transmission power is selected correctly.

After the transmission power of the Ethernet device 100 is adjusted, the link monitoring unit 13 determines the transmission power is selected erroneously when a link down is detected by the Ethernet device 100 during a predetermined time. In this situation, the embodiment of the present invention can reset the power budget controller 10, i.e. executing the process 30 once again, to re-adjust the transmission power of the Ethernet device 100.

Consequently, the embodiment of the present invention not only adjusts the transmission power for reduction of unnecessary power consumption according to the length of the cable which the Ethernet device is connected with, but also avoids the link down problem due to incorrect estimation of the cable length by monitoring the link status of the Ethernet device.

Preferably, the power budget controller 10 according to the embodiment of the present invention can numerously estimate the length of the cable (i.e. repeat Step 310) to avoid erroneously estimating the length of the cable. In addition, the power selection unit 12 could be realized by performing table look-up to determine the transmission power of the Ethernet device 100 according to the estimation result of the cable length. Such variations are also included in the scope of the present invention.

To sum up, the embodiment of the present invention adjusts the transmission power to reduce unnecessary power consumption according to the cable length of the Ethernet device. Apart from that, the embodiment of the present invention further avoids the link down problem caused by incorrect power adjustment by monitoring the link status of the Ethernet device.

Those skilled in the art will readily observe that numerous modifications and alterations of the device and method may be made while retaining the teachings of the invention.

What is claimed is:

1. A power budget controller for an Ethernet device, the power budget controller comprising:
a length estimation unit for generating a detection signal to a cable and estimating a length of the cable according to a reflection waveform of the detection signal;
a power selection unit coupled to the length estimation unit, for adjusting a transmission power of the Ethernet device according to an estimation result of the cable length; and
a link monitoring unit coupled to the power selection unit, for monitoring a link status of the Ethernet device to determine whether the transmission power is selected correctly.

2. The power budget controller of claim 1, wherein the length estimation unit comprises:
a reception unit coupled to the cable, for receiving the reflection waveform of the detection signal;
a correlation operation unit coupled to the reception unit, for calculating a correlation between the reflection waveform and an expected reflection waveform of the detection signal; and
a determination unit coupled to the correlation operation unit, for determining whether the length of the cable is less than a particular value according to the correlation between the reflection waveform and the expected reflection waveform.

3. The power budget controller of claim 2, wherein the determination unit estimates the length of the cable according to a start time of the reflection waveform when the length of the cable is greater than the particular value.

4. The power budget controller of claim 2, wherein the determination unit determines the length of the cable is greater than the particular value when the reflection waveform and the expected reflection waveform show a strong correlation, and the determination unit determines the length of the cable is less than the particular value when the refection waveform and the expected reflection waveform show a weak correlation.

5. The power budget controller of claim 2, wherein the particular value is twenty meters.

6. The power budget controller of claim 1, wherein the power selection unit performs a table look-up operation to determine the transmission power of the Ethernet device according to the estimation result of the cable length.

7. The power budget controller of claim 1, wherein the link monitoring unit determines the transmission power is selected erroneously and resets the power budget controller to re-adjust the transmission power when the Ethernet device has a link down.

8. The power budget controller of claim 1, wherein the detection signal is a link pulse signal.

9. The power budget controller of claim 1, wherein the link monitoring unit monitors the link status of the Ethernet device through a link monitor process.

10. A method of controlling power budget for an Ethernet device, the method comprising:
generating a detection signal to a cable and estimating a length of the cable according to a reflection waveform of the detection signal;
adjusting a transmission power of the Ethernet device according to an estimation result of the cable length; and
monitoring a link status of the Ethernet device to determine whether the transmission power is selected correctly.

11. The method of claim 10, wherein the step of estimating the length of the cable according to the reflection waveform of the detection signal comprises:
determining whether the length of the cable is less than a particular value according to a correlation between the reflection waveform and an expected reflection waveform of the detection signal; and
estimating the length of the cable according to a start time of the reflection waveform when the length of the cable is greater than the particular value.

12. The method of claim 11, wherein the step of determining whether the length of the cable is less than the particular value according to the correlation between the reflection waveform and the expected reflection waveform comprises:
determining the length of the cable is greater than the particular value when the reflection waveform and the expected reflection waveform show a strong correlation, and determining the length of the cable is less than the particular value when the refection waveform and the expected reflection waveform show a weak correlation.

13. The method of claim 11, wherein the particular value is twenty meters.

14. The method of claim 10, wherein the step of adjusting the transmission power of the Ethernet device according to the estimation result of the cable length comprising:
performing a table look-up operation to determine the transmission power of the Ethernet device according the estimation result.

15. The method of claim 10, wherein the step of monitoring the link status of the Ethernet device to determine whether the transmission power is selected correctly comprises:
determining the transmission power is selected erroneously and resetting the power budget controller to re-adjust the transmission power when the Ethernet device has a link down.

16. The method of claim 10, wherein the detection signal is a link pulse signal.

17. The method of claim 10, wherein the step of monitoring the link status of the Ethernet device to determine whether the transmission power is selected correctly is monitoring the link status of the Ethernet device through a link monitor process.
